(19) United States
(12) Patent Application Publication
(10) Pub. No.: US 2016/0069760 A1
(43) Pub. Date: Mar. 10, 2016

(54) INTERACTIVE PRESSURE CONTROL SYSTEM

(71) Applicant: GRIP PLUS INC, MENLO PARK, CA (US)

(72) Inventor: SAI MING CHIANG, REDWOOD CITY, CA (US)

(21) Appl. No.: 14/483,033

(22) Filed: Sep. 10, 2014

(51) Int. Cl. G01L 5/00; G01B 21/00; G08B 21/18

(52) U.S. Cl. CPC G01L 5/00; G08B 21/182; G01B 21/00

(57) ABSTRACT

A system includes at least one pressure sensor coupled to a surface of a handheld instrument. The system further includes a controller. An input of the controller is coupled to the at least one pressure sensor. The system also includes a memory device coupled to the controller. The memory device includes a stored pressure level.

### FIELD OF THE DISCLOSURE

The present disclosure related generally to pressure level measurement and more particularly to an interactive pressure control system.

### BACKGROUND

Acquiring skills in sports and other activities often requires participants to become proficient at using various tools or pieces of equipment. Extensive training enables users of the tools or pieces of equipment to develop ‘muscle memory’ which enables the users to use the tools or pieces of equipment with a high level of consistency.

In order to develop consistency in using a particular tool or piece of equipment, a user may need to be able to apply the same amount of pressure at particular locations of the tool or piece of equipment with each use. While a user trains using a particular tool or piece of equipment, it is often difficult for the user to determine a pressure level that the user is applying to particular locations at the tool or piece of equipment. This is particularly true of sports equipment devices because sports equipment is often used in the heat of a match or practice session where the user's mind is otherwise employed. As the user may be unable to determine a pressure level applied to the tool or piece of equipment, it may be difficult for the user to develop consistency in using the tool or piece of equipment.

### SUMMARY

Disclosed is an interactive pressure control system to provide feedback to a user regarding the amount of pressure applied by the user to a particular location on a surface of a handheld instrument, which may also include a glove that the user wears while the user trains with a tool or piece of equipment.

In an embodiment, a method includes receiving from a pressure sensor an indication of a pressure level detected at one or more locations on a surface of a handheld instrument. The method further includes comparing, at a controller, the detected pressure level to a pressure level range. In response to the pressure level falling outside of the pressure level range, the method also includes generating an output at the controller. The output is indicative of the pressure falling outside of the pressure level range.

In an embodiment, the method further includes receiving from a motion sensor an indication of a velocity or acceleration level detected at the handheld instrument and comparing, at the controller, the detected velocity or acceleration level to a velocity or acceleration level range. In response to the velocity or acceleration level falling outside of the velocity or acceleration level range, the method may include generating the output at the controller.

In an embodiment, the handheld instrument is a glove and the surface is an inside surface or an outside surface of the glove. In an embodiment, the handheld instrument is a shotgun forend, a shotgun hand grip, a shotgun cheek comb, a shotgun buttpad, a rifle forend, a rifle hand grip, a rifle cheek comb, a rifle buttpad, or a pistol grip. In an embodiment, the handheld instrument is a baseball bat, a tennis racket, or a golf club.

In an embodiment, the output includes a change in a voltage or current at an output terminal, the change in the voltage detectable by a voltage or current meter. In an embodiment, the output includes data sent to a liquid crystal diode (LCD) information display, to a light emitting diode (LED) bar graph level display, to an LED digital display, or a combination thereof. In an embodiment, the output includes signals sent to a shaft or shaftless vibrate motor. In an embodiment, the output includes signals sent to a buzzer or a speaker.

In an embodiment, the method further includes generating data indicative of a plurality of samplings of the pressure level at the one or more locations over a period of time. The method may further include sending the data indicative of the plurality of samplings to a remote computing device. The data may be sent to the remote computing device via bluetooth, wifi, or wireless USB.

In an embodiment, the method further includes generating data indicative of a plurality of samplings of a velocity or acceleration level at the handheld instrument over a period of time. The method may further include sending the data indicative of the plurality of samplings to a remote computing device.

In an embodiment, the method also includes receiving user input. The method may further include storing the user input as a stored pressure level, a stored velocity or acceleration level, or both. The method may include generating the pressure level range, a velocity or acceleration level range, or both, based on the stored input.

In an embodiment, a system includes at least one pressure sensor coupled to a surface of a handheld instrument. The system further includes a controller. An input of the controller is coupled to the at least one pressure sensor. The system also includes a memory device coupled to the controller. The memory device includes a stored pressure level. The system includes an output interface coupled to the controller.

In an embodiment, the system further includes at least one motion sensor coupled to the handheld instrument and electronically coupled to the controller. The memory device may further include a stored velocity or acceleration level.

The at least one pressure sensor may include a pressure resistant sensor, a capacitive sensor, an inductive sensor, a mechanical pressure sensor, or a combination thereof. The motion sensor may include an accelerometer, a gyroscope, a camera, a radar, a range finder, or a combination thereof. The controller may include a comparator, an amplifier, an analog-to-digital converter, a micro-controller, or a combination thereof. The memory device may include a variable resistor, a variable capacitor, a digital register element, a random access memory (RAM) element, or a combination thereof. The output interface may include an audio output, a video output, a digital output, a data output, or a combination thereof.

In an embodiment, an apparatus includes a glove. The apparatus further includes at least one pressure sensor coupled to a surface of the glove. The at least one pressure sensor is configured to measure a pressure level at a surface of the glove and send the pressure level to a controller to compare the pressure level to a pressure level range.

In an embodiment, the apparatus further includes at least one motion sensor coupled to the glove. The at least one motion sensor may be configured to measure a velocity or acceleration at the glove and send the velocity or acceleration to the controller. The pressure level range may correspond to a target pressure level corresponding to a tool or piece of equipment. The target pressure level is selected from a plurality of target pressure levels corresponding to a plurality of tools or pieces of equipment.

A benefit of the interactive pressure control system is that a user of the handheld instrument, receives feedback on whether a correct, or target, amount of pressure is being applied by the user at particular locations on the surface of the handheld instrument. For example, the user may be training with the handheld device, tool, or piece of equipment and may use the feedback to adjust the user's grip. As the user trains, the user's grip may become more consistent as the user relies on the feedback received from the interactive pressure control system.

### BRIEF DESCRIPTION OF THE DRAWINGS

FIG. 1 illustrates a block diagram of one embodiment of an interactive pressure control system;

FIG. 2 illustrates a block diagram of one embodiment of an interactive pressure control system including a comparator;

FIG. 3 illustrates a block diagram of one embodiment of an interactive pressure control system including a processor and a memory;

FIG. 4 illustrates an embodiment of a shotgun usable with an interactive pressure control system;

FIG. 5 illustrates an embodiment of a handgun usable with an interactive pressure control system;

FIG. 6 illustrates an embodiment of a rifle usable with an interactive pressure control system;

FIG. 7 illustrates an embodiment of a baseball bat usable with an interactive pressure control system;

FIG. 8 illustrates an embodiment of a tennis racket usable with an interactive pressure control system;

FIG. 9 illustrates an embodiment of a golf club usable with an interactive pressure control system;

FIG. 10 illustrates an embodiment of a glove usable with an interactive pressure control system;

FIG. 11 illustrates a flow diagram of an embodiment of a method of performing interactive pressure control.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

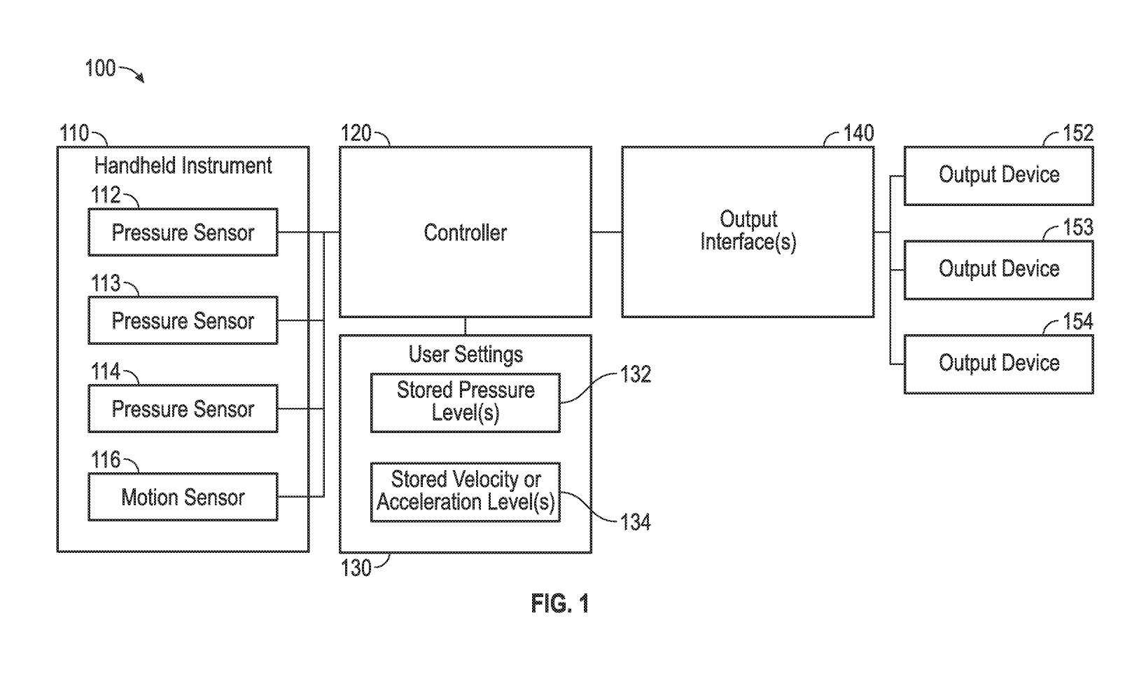

Referring to FIG. 1, a block diagram of an embodiment of an interactive pressure control system is depicted and generally designated 100. The interactive pressure control system 100 may include a handheld instrument 110, a controller 120, user settings 130, and one or more output interfaces 140. Although FIG. 1 depicts the controller 120, the user settings 130, and the one or more output interfaces 140 as distinct from the handheld instrument, in one or more other embodiments, at least one of the controller 120, the user settings 130, and the one or more output interfaces 140 are included as part of the handheld instrument 110.

The handheld instrument 110 may include one or more pressure sensors 112-114. The pressure sensors 112-114 may be configured to detect a pressure level at one or more locations on a surface of the handheld instrument 110. For example, the pressure sensors 112-114 may be coupled to (e.g., integrated onto or underneath) the surface of the handheld instrument 110 at particular locations. As a user applies pressure to the surface of the handheld instrument 110, the pressure sensors 112-114 may detect and/or measure a pressure level at the particular locations. The pressure sensors 112-114 may be configured to send an indication of the pressure level to the controller 120. For example, one or more pressure sensors 112-114 may be electrically coupled to an input of the controller 120. One or more of the pressure sensors 112-114 may include a pressure resistive sensor, a capacitive sensor, an inductive sensor, a mechanical pressure sensor, another type of pressure sensor, or a combination thereof. Although FIG. 1 depicts the handheld instrument 110 as including three pressure sensors, in other embodiments, the handheld instrument 110 may include more or fewer than three pressure sensors.

The handheld instrument 110 may further include a motion sensor 116. The motion sensor 116 may be configured to detect a velocity or an acceleration level at the handheld instrument 110. For example, the motion sensor 116 may include an accelerometer. As a user moves the handheld instrument 110, the accelerometer may detect accelerations associated with the movement. In one or more embodiments, the accelerometer may determine relative velocities based on the detected accelerations. These velocities or acceleration levels may be sent from the handheld instrument 110 to the controller 120. In one or more embodiments, the motion sensor 116 may include a gyroscope configured to detect the acceleration level. In one or more embodiments, the motion sensor 116 may include a device configured to detect a velocity of the handheld instrument 110 relative to one or more objects proximate to the handheld instrument 110. To illustrate, the motion sensor 116 may include a camera, a radar, a range finder, or a combination thereof, configured to detect movement of the handheld device 110 relative to objects or surfaces near the handheld device 110. In an embodiment, the motion sensor 116 may include a combination of one or more of the devices listed herein. For example, the motion sensor 116 may include an accelerometer, a gyroscope, a camera, a radar, a range finder, or a combination thereof.

Although FIG. 1 depicts the system 100 as including the motion sensor 116, in one or more other embodiments, the system 100 may omit the motion sensor 116. For example, in some embodiments, only one or more pressure levels are detected at the handheld instrument 110.

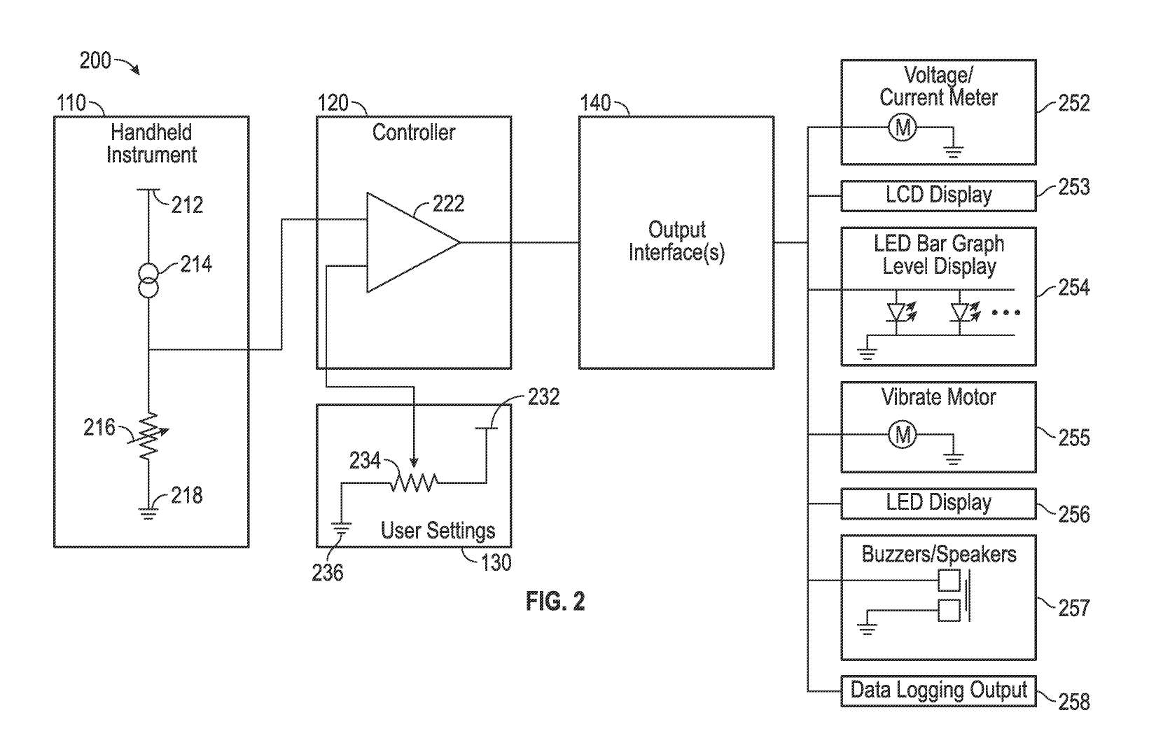

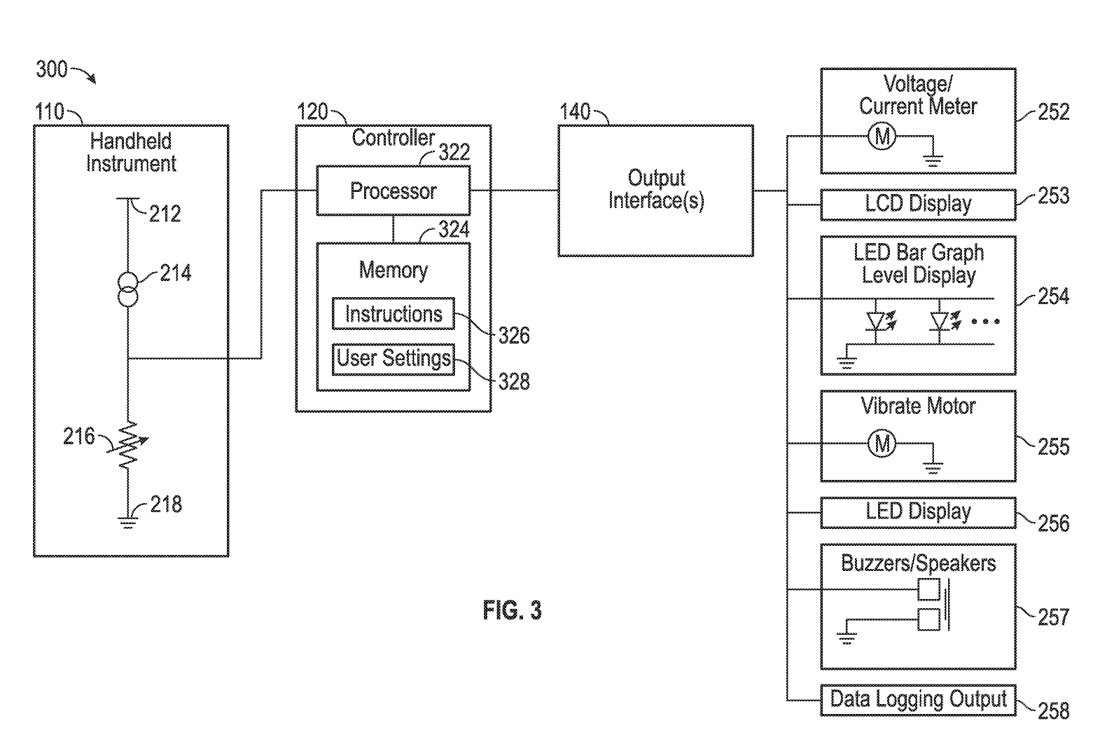

The controller 120 may perform control functions as described herein. For example, the controller may be configured to generate an output based on an indication of the pressure level received from the pressure sensors 112-114. The controller may be further configured to generate the output based on an indication of a velocity or acceleration level received from the motion sensor 116. The controller may include a comparator, an amplifier, an analog-to-digital converter, a micro-controller, another type of computing or comparing device, or a combination thereof. Particular embodiments of the controller 120 are further described with reference to FIGS. 2 and 3.

The user settings 130 may include data indicating one or more stored pressure levels 132. For example, the one or more stored pressure levels 132 may be stored at an analog or digital memory device. The memory device may include a variable resistor, a variable capacitor, a digital register element, a random access memory (RAM) element, another type of analog or digital memory device, or a combination thereof, as described further with reference to FIGS. 2 and 3.

The one or more stored pressure levels 132 may correspond to target pressure levels set by a user in order to enhance training using the handheld instrument 110. In an embodiment, the one or more stored pressure levels 132 are set by the user via a user interface. The user interface may include a digital input, an analog input, or a combination thereof. For example, the user interface may include a digital keypad, a touchscreen interface, a communication link to a remote digital device, a dial, a knob, another type of digital or analog input interface, or a combination thereof. Alternatively or in addition, the user may set the one or more stored pressure levels 132 using one or more of the pressure sensors 112-114. For example, the system 100 may be configured to operate in a configuration state and in an operating state. The configuration state may enable the user to set the one or more stored pressure levels 132 by applying a pressure to one or more of the pressure sensors 112-114. The controller may be configured to store data corresponding to a pressure level associated with the one or more pressure sensors 112-114. After data corresponding to one or more pressure levels 132 is stored at the user settings 130, the handheld instrument 100 may be switched from the configuration state to the operating state.

The one or more stored pressure levels 132 may include pressure levels corresponding to each of the pressure sensors 112-114. To illustrate in a non-limiting example, a user may determine that using the handheld instrument 110 is particularly effective when 15 lbs. per square inch is applied to a location of the pressure sensor 112, when 20 lbs. per square inch is applied to a location of the pressure sensor 113, and when 10 lbs. per square inch is applied to a location of the pressure sensor 114. During a configuration state, the user may set, using the user interface and/or the pressure sensors 112-114, the one or more stored pressure levels 132 to include a value of 20 lbs. corresponding to the pressure sensor 112, a value of 15 lbs. per square inch corresponding to the pressure sensor 113, and a value of 10 lbs. per square inch corresponding to the pressure sensor 114. The one or more stored pressure levels 132 may be compared to pressure levels detected by the pressure sensors 112-114 during use of the handheld instrument 110, as described herein.

In an embodiment, the one or more stored pressure levels 132 include a pressure level range corresponding to each of the pressure sensors 112-114. For example, if the user determines that using the handheld instrument 110 is particularly effective when 15 lbs. per square inch is applied to a location of the pressure sensor 112, then the user may set the one or more stored pressure levels 132, depending on a desired operation of the interactive pressure control system 100, to include one or more of the following ranges: (1) the range of pressure levels less than or equal to 15 lbs.; (2) the range of pressure levels within an upper and/or lower threshold of 15 lbs.; and (3) the range of pressure levels greater than or equal to 15 lbs. In some embodiments, the pressure level range may be generated at a time that a pressure level is received at the controller 120 from one or more of the pressure sensors 112-114 (e.g., on the fly) as opposed to being stored in the user settings 130. In both cases, the controller 110 may compare a pressure level indicated by one or more of the pressure sensors 112-114 to the pressure level range. When the pressure level falls outside the pressure level range, the controller 110 may generate an output and send the output to the one or more output interfaces 140.

The user settings 130 may further include one or more stored velocity or acceleration levels 134. Similar to the stored pressure levels 132, the stored velocity or acceleration levels 134 may be stored at an analog or digital memory device and may correspond to one or more target velocity or acceleration levels. Further, the stored velocity or acceleration levels 134 may be received via a user interface, via the motion sensor 116, or both.

The one or more output interfaces 140 may provide circuits and/or mechanisms for the controller 120 to transmit an output to one or more output devices 152-154. For example, the output interface may include an audio output, a video output, a digital output, a data output, another type of analog or digital output, or a combination thereof. After generating an output based on an indication of a pressure level received from one or more of the pressure sensors 112-114 and based on the one or more stored pressure levels 132, the controller 120 may transmit a signal indicating the output to one or more of the output devices 152-154 via the one or more output interfaces 140. The one or more output interfaces 140 may translate or modify the signal received from the controller to be compatible with the output devices 152-154. Particular embodiments the output devices 152-154 are described further with reference to FIGS. 2 and 3. Although FIG. 1 depicts the system 100 as including three output devices, in other embodiments, the system 100 may include more than three or fewer than three output devices. Further, in one or more embodiments, the output devices 152-154 may be incorporated into or includes as part of the handheld instrument 110.

During operation, the handheld instrument 110 may sense a pressure level at one or more locations of the handheld instrument 110. For example, as a user handles or trains with the handheld instrument 110, a pressure may be applied to a location of a surface of the handheld instrument 110. A pressure level at the location may be detected by one or more of the pressure sensors 112-114 and an indication of the pressure level may be sent from the one or more of the pressure sensors 112-114 to the controller 120. The controller 120 may compare the pressure level to one of the one or more stored pressure levels 132 and/or to a pressure level range. For example, the controller 120 may generate the pressure level range based on the one or more stored pressure levels 132. In response to the pressure level being unequal to the one of the one or more stored pressure levels 132 and/or in response to the pressure level falling outside of a pressure level range corresponding to the one of the one or more stored pressure levels 132, the controller 120 may generate an output. The output may indicate that the pressure level falls outside of the pressure level range. In an embodiment, the output may further indicate a value corresponding to the pressure level. The output may be communicated to a user at the output devices 152-154 via the one or more output interfaces 140.

The handheld instrument 110 may also sense a velocity or acceleration level at one or more locations of the handheld instrument 110. For example, as the user handles or trains with the handheld instrument 110, the handheld instrument 110 may be moved, twisted, or swung. A velocity or acceleration level of the handheld instrument 110 may be detected by the motion sensor 116 and sent to the controller 120. The controller 120 may compare the velocity or acceleration level to the one or more stored velocity or acceleration levels 134. In response to the velocity or acceleration level being unequal to the one or more stored velocity or acceleration levels 134 and/or in response to the velocity or acceleration level falling outside of a velocity or acceleration level range corresponding to the one or more stored velocity or acceleration levels 134, the controller 120 may generate the output.

A benefit of the interactive pressure control system 100 is that a user of the handheld instrument 110 may receive feedback on whether a correct or target amount of pressure is being applied by the user at particular locations of the handheld instrument 112-114. For example, the user may be training with the handheld instrument 110 and may use the feedback to adjust the user's grip on the handheld instrument 110. As the user trains, the user's grip may become more consistent as the user relies on the feedback received from the interactive pressure control system 100. In embodiments that include the motion sensor 116, the user may also receive feedback on whether the handheld instrument 110 is moving at a correct or target velocity or acceleration level. As the user trains, the velocity or acceleration level at which the user employs the handheld instrument 110 may also become more consistent.

Referring to FIG. 2, a block diagram of an embodiment of an interactive pressure control system is depicted and generally designated 200. The interactive pressure control system 200 may include the handheld instrument 110, the controller 120, the user settings 130, and the one or more output interfaces 140. Further, the interactive pressure control system 200 may include one or more output devices 252-258 including a voltage/current meter 252, a liquid crystal diode (LCD) display 253, and light emitting diode (LED) bar graph level display 254, a vibrate motor 255, an LED display 256, a buzzer or speaker 257, and/or a data logging output 258. One or more of the output devices 252-258 may correspond to one or more of the output devices 152-154.

The handheld instrument 110 may include a power source 212, a biasing circuit 214, a sensing circuit 216, and a common or ground 218. The power source 212, the biasing circuit 214, the sensing circuit 216, and the common or ground 218 may correspond to one or more of the pressure sensors 112-114. The biasing circuit 214 may be positioned between the power source and the sensing circuit 216 and may provide a bias voltage for generating an output from the sensing circuit 216.

The sensing circuit 216 may be configured to sense a pressure level applied to the sensing circuit 216 or to a location of a surface of the handheld instrument 110 to which the sensing circuit 216 is coupled. For example, a resistance of the sensing circuit 216 may be changed based on a pressure level applied to the sensing circuit. The change in resistance may be used in conjunction with the biasing circuit 214 to alter a voltage output received by the controller 120. Although FIG. 2 depicts the sensing circuit 216 as a pressure resistive sensor, in one or more other embodiments, the sensing circuit 216 may include a capacitive sensor, an inductive sensor, a mechanical pressure sensor, another type of pressure sensor, or a combination thereof.

The user settings 130 may include a power source 232, a variable resistor 234, and a common or ground 236. The power source 232, the variable resistor 234, and the common or ground 236 may enable storage of the one or more stored pressure levels 132 (shown in FIG. 1). For example, a user may adjust the variable resistor to a particular resistance associated with a target pressure level. The target pressure level may correspond to a location on a surface of the handheld instrument 110. A signal may be generated at the variable resistor 234 based on the particular resistance. The signal may be sent to the controller 120. Although FIG. 2 depicts the user settings 130 as including a variable resistor 234, in one or more other embodiments, the user settings 130 may include a variable capacitor, a variable inductor, one or more other types of variable memory devices, or a combination thereof.

The controller 120 may include a comparator 222 to compare a signal indicating a pressure level received from the sensing circuit 216 to a signal indicating a stored pressure level received from the variable resistor 234. The controller 120 may further include additional circuitry such as signal conditioner circuits, amplifiers, etc. The additional circuitry may enable the controller 120 to determine whether a pressure level at the handheld device falls outside a pressure level range. The pressure level range may be based on the signal received from the variable resistor 234. For example, the additional circuitry may include additional comparators, amplifiers, signal conditioning circuits, and other circuitry to generate a pressure level range as will be understood by persons of ordinary skill in the art having the benefit of this disclosure. In response to the pressure level at the handheld instrument 110 falling outside the pressure level range, the controller 120 may generate an output and send the output to the output interface 140. The output interface 140 may in turn generate a signal readable by one or more of the outputs 252-258.

Although FIG. 2 depicts the handheld instrument 110 as not including a motion sensor, in one or more other embodiments the handheld instrument 110 includes a motion sensor and the user settings 130 include one or more velocity or acceleration levels as described with reference to FIG. 1.

The voltage/current meter 252 may indicate a voltage or current change in response to a signal from the controller 120. For example, the output interface 140 may be configured to generate, or pass along from the controller 120, a change in a voltage or current. The change in voltage or current may be detected by the voltage/current meter 252. Depending on the magnitude of the change in the voltage or current, a user of the handheld instrument 110 may determine whether the interactive pressure control system 200 is indicating that a pressure level applied at a location of a surface of the handheld instrument 110 falls outside a pressure level range and/or whether a velocity or acceleration level detected at the handheld instrument 110 falls outside a velocity or acceleration level range.

The LCD display 253 may, additionally or alternatively, indicate that the pressure level falls outside of a pressure level range and/or that a velocity or acceleration level detected at the handheld instrument 110 falls outside a velocity or acceleration level range. For example, in response to an output of the controller 110, the one or more output interfaces 140 may generate a digital display readout to be displayed at the LCD display 253. The digital display readout may be sent as data to the LCD display 253, which may in turn display the digital display readout.

The LED bar graph level display 254 may, additionally or alternatively, indicate that the pressure level falls outside of a pressure level range and/or that a velocity or acceleration level detected at the handheld instrument 110 falls outside a velocity or acceleration level range. For example, regarding the pressure level, the LED bar graph level display 254 may be configured to indicate a magnitude of a difference between the pressure level received from the handheld instrument 110 and the stored pressure level received from the user settings. To illustrate, the one or more output interfaces 140 may generate an output signal that includes signals sent to the LED bar graph level display 254. The LED bar graph level display 254 may activate one or more LEDs in response to the signal. A number of LEDs of the LED bar graph display 254 that are activated may depend on a difference between the pressure level and the stored pressure level received from the user settings 130. The LEDs may be aligned such that a user may determine from the LEDs whether the interactive pressure control system 200 indicates that a pressure level applied at a location of a surface of the handheld instrument 110 falls outside a pressure level range, and to what extend the pressure level falls outside the pressure level range. The LED bar graph level display 254 may perform similar operations regarding the velocity or acceleration level.

The vibrate motor 255 may, additionally or alternatively, indicate that the pressure level falls outside of a pressure level range and/or that a velocity or acceleration level detected at the handheld instrument 110 falls outside a velocity or acceleration level range. For example, the one or more output interfaces 140 may generate an output that includes signals directing the vibrate motor 255 to vibrate. The vibrate motor 255 may include a shaft type or shaft-less type vibrate motor. Vibrations generated by the vibrate motor 255 may enable a user to determine whether the interactive pressure control system 200 is indicating that a pressure level applied at a location of a surface of the handheld instrument 110 falls outside a pressure level range and/or whether a velocity or acceleration level detected at the handheld instrument 110 falls outside a velocity or acceleration level range.

The LED display 256 may, additionally or alternatively, indicate that the pressure level falls outside of a pressure level range and/or that a velocity or acceleration level detected at the handheld instrument 110 falls outside a velocity or acceleration level range. For example, the one or more of the output interfaces 140 may translate an output of the controller 120 into signals that may be sent to the LED display 256. The LED display 256 may include an analog type LED display or a digital type LED display.

The buzzer or speaker 257 may, additionally or alternatively, indicate that the pressure level falls outside of a pressure level range and/or that a velocity or acceleration level detected at the handheld instrument 110 falls outside a velocity or acceleration level range. For example, the one or more output interfaces 140 may translate an output of the controller 120 into signals sent that may be sent to the buzzer or speaker 257. In response to the signals, the buzzer or speaker 257 may generate an audible signal to indicate to a user that the pressure level at the handheld instrument 110 falls outside of a pressure level range and/or that the velocity or acceleration level detected at the handheld instrument 110 falls outside a velocity or acceleration level range.

The data logging output 258, additionally or alternatively, indicate that the pressure level falls outside of a pressure level range and/or that a velocity or acceleration level detected at the handheld instrument 110 falls outside a velocity or acceleration level range. For example, the one or more output interfaces 140 may generate data that may be sent to a remote device capable of performing data logging. The remote device may include a mobile device such as a laptop, mobile phone, tablet, portable music player, portable gaming device, or other type of mobile computing device. The remote device may further include a personal computing device such as a desktop, a set-top box, a customer premises equipment device, a gaming console, etc. In response to receiving the data, the remote device may provide an indication to a user that the pressure level falls outside of a pressure level range and/or that a velocity or acceleration level detected at the handheld instrument 110 falls outside a velocity or acceleration level range.

In an embodiment, the controller 120 may be configured to generate data indicative of a plurality of samplings of the pressure level at the one or more locations over a period of time. Further, the controller 120 may be configured to generate data indicative of a plurality of samplings of a velocity or acceleration level at the handheld device 110 over a period of time. The data indicative of the plurality of samplings may be sent to the remote device via a wired or wireless communications protocol such as bluetooth, wi-fi, wireless USB, etc. The plurality of samplings may enable to user to monitor progress during training with the handheld instrument 110. Although FIG. 2 illustrates the interactive pressure control system 200 as including each of output devices 252-258, in one or more other embodiments, the interactive pressure control system 200 may omit one or more of the output devices 252-258.

Referring to FIG. 3, a block diagram of an embodiment of an interactive pressure control system is depicted and generally designated 300. The interactive pressure control system 300 may include the handheld instrument 110, the controller 120, the one or more output interfaces 140, and one or more of the output devices 252-258.

In the embodiment depicted in FIG. 3, the controller 120 may include a processor 322 and a memory 324. The processor 332 may include a central processing unit (CPU), a digital signal processor (DSP), another type of microprocessor, or a combination thereof. The memory may include register-based memory, random access memory (RAM), read only memory (ROM), solid state memory, magnetic memory, resistive memory, or a combination thereof.

The memory may include instructions 326 and user settings 328. The user settings 328 may correspond to the user settings 130. For example, the user settings 328 may include data indicating at least one stored pressure level or at least one stored pressure level range. Further, in one or more other embodiments, the user settings 328 include one or more velocity or acceleration levels and the handheld instrument 110 includes a motion sensor as described with reference to FIG. 1.

The instructions 326 may include processor readable instructions that, when executed by the processor 322 cause the processor 322 to perform operations including, comparing an indication of a pressure level received from the handheld instrument 110 to a pressure level or pressure level range stored in the user settings 328. When the pressure level falls outside the pressure level range, the operations may include sending a signal to one or more of the outputs 252-258 via the one or more output interfaces 140. The operations may further include comparing a detected velocity or acceleration level received from the handheld instrument 110 to a velocity or acceleration level range stored in the user settings 328. When the velocity or acceleration level falls outside of the velocity or acceleration level range, the operations may include sending the signal to one or more of the outputs 252-258. The operations may also include generating data indicative of a plurality of samplings of the pressure level and/or the velocity or acceleration level at the one or more locations over a period of time and sending the data to the data logging output 258. The data logging output 258 may further communicate the data to a remote device as described herein.

Although FIGS. 1-3 depict one or more output interfaces 140, in one or more other embodiments, the controller 120 may be electrically coupled directly to one or more of the outputs 152-154 and/or one or more of the outputs 252-258. Further, in one or more other embodiments, the one or more output interfaces 140 may be integrated into the controller 120.

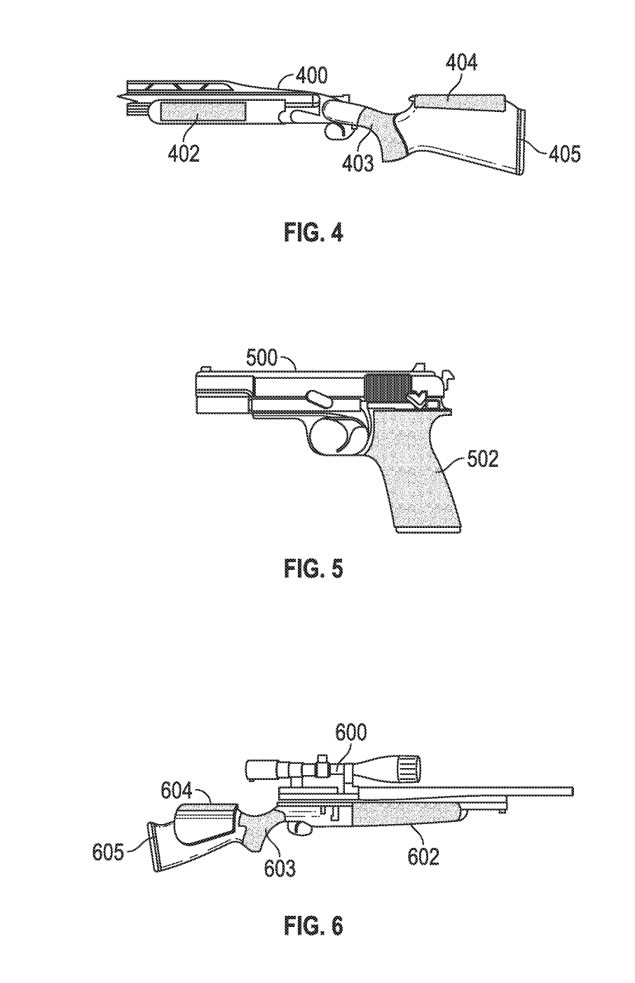

Referring to FIG. 4, an illustration of an embodiment of a shotgun 400 usable with an interactive pressure control system is depicted. The shotgun 400 may include multiple pressure sensors 402-405. For example, at least one pressure sensor 402 may be located on a surface of a forend of the shotgun 400, at least one pressure sensor 403 may be located on a surface of a handgrip of the shotgun 400, at least one pressure sensor 404 may be located on a surface of a cheekcomb of the shotgun 400, and at least one pressure sensor 405 may be located on a surface of a buttpad of the shotgun. One or more of the pressure sensors 402-405 may correspond to one or more of the pressure sensors 112-114. For example, the shotgun 400 may correspond to the handheld instrument 110. Alternatively, one or more of the forend, the hand grip, the cheek comb, and the buttpad may correspond to the handheld instrument 110.

By using the shotgun 400 in conjunction with the interactive pressure control system 100, a user of the shotgun 400 may receive feedback regarding the pressure applied to particular locations of the shotgun while the user trains with the shotgun 400. For example, the user may receive feedback regarding the pressure the user applied to one of the forend, the hand grip, the cheekcomb, and the buttpad of the shotgun 400.

Referring to FIG. 5, an illustration of an embodiment of a handgun 500 usable with an interactive pressure control system is depicted. The handgun 500 may include at least one pressure sensor 502. For example, the pressure sensor 502 may be located on a surface of a handle of the handgun 500. The at least one pressure sensor 502 may correspond to one or more of the pressure sensors 112-114. For example, the handgun 500 may correspond to the handheld instrument 100.

By using the handgun 500 in conjunction with the interactive pressure control system 100, a user of the handgun 500 may receive feedback regarding the pressure applied to particular locations of the handgun 500 while the user trains with the handgun 500. For example, the user may receive feedback regarding the pressure the user applies to the handle of the handgun 500.

Referring to FIG. 6, an illustration of an embodiment of a rifle 600 usable with an interactive pressure control system is depicted. The rifle 600 may include multiple pressure sensors 602-605. For example, at least one pressure sensor 602 may be located on a surface of a forend of the rifle 600, at least one pressure sensor 603 may be located on a surface of a handgrip of the rifle 600, at least one pressure sensor 604 may be located on a surface of a cheekcomb of the rifle 600, and at least one pressure sensor 605 may be located on a surface of a buttpad of the rifle 600. One or more of the pressure sensors 602-605 may correspond to one or more of the pressure sensors 112-114. For example, the rifle 600 may correspond to the handheld instrument 110. Alternatively, one or more of the forend, the hand grip, the cheek comb, and the buttpad may correspond to the handheld instrument 110.

By using the rifle 600 in conjunction with the interactive pressure control system 100, a user of the rifle 600 may receive feedback regarding the pressure applied to particular locations of the rifle 600 while the user trains with the rifle 600. For example, the user may receive feedback regarding the pressure the user applies to one of the forend, the hand grip, the cheekcomb, and the buttpad of the rifle 600.

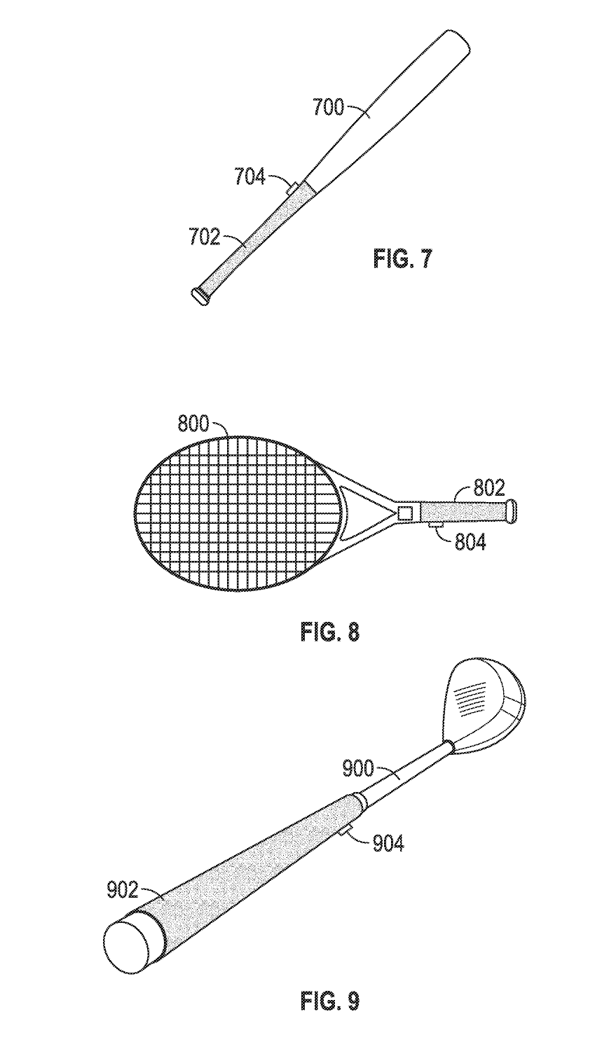

Referring to FIG. 7, an illustration of an embodiment of a baseball bat 700 usable with an interactive pressure control system is depicted. The baseball bat 700 may include at least one pressure sensor 702. For example, the pressure sensor 702 may be located on a surface of a handle of the baseball bat 700. The at least one pressure sensor 702 may correspond to one or more of the pressure sensors 112-114. For example, the baseball bat 700 may correspond to the handheld instrument 100. The baseball bat 700 may further include at least one motion sensor 704. The motion sensor 704 may correspond to the motion sensor 116.

By using the baseball bat 700 in conjunction with the interactive pressure control system 100, a user of the baseball bat 700 may receive feedback regarding the pressure applied to particular locations of the baseball bat 700 while the user trains with the baseball bat 700. For example, the user may receive feedback regarding the pressure the user applies to the handle of the baseball bat 700. Further, the user may receive feedback regarding a velocity or acceleration level of the baseball bat 700.

Referring to FIG. 8, an illustration of an embodiment of a tennis racket 800 usable with an interactive pressure control system is depicted. The tennis racket 800 may include at least one pressure sensor 802. For example, the pressure sensor 802 may be located on a surface of a handle of the tennis racket 800. The at least one pressure sensor 802 may correspond to one or more of the pressure sensors 112-114. For example, the tennis racket 800 may correspond to the handheld instrument 100. The tennis racket 800 may further include at least one motion sensor 804. The motion sensor 804 may correspond to the motion sensor 116.

By using the tennis racket 800 in conjunction with the interactive pressure control system 100, a user of the tennis racket 800 may receive feedback regarding the pressure applied to particular locations of the tennis racket 800 while the user trains with the tennis racket 800. For example, the user may receive feedback regarding the pressure the user applies to the handle of the tennis racket 800. Further, the user may receive feedback regarding a velocity or acceleration level of the tennis racket 800.

Referring to FIG. 9, an illustration of an embodiment of a golf club 900 usable with an interactive pressure control system is depicted. The golf club 900 may include at least one pressure sensor 902. For example, the pressure sensor 902 may be located on a surface of a handle of the golf club 900. The at least one pressure sensor 902 may correspond to one or more of the pressure sensors 112-114. For example, the golf club 900 may correspond to the handheld instrument 100. The golf club 900 may further include at least one motion sensor 904. The motion sensor 904 may correspond to the motion sensor 116.

By using the golf club 900 in conjunction with the interactive pressure control system 100, a user of the golf club 900 may receive feedback regarding the pressure applied to particular locations of the golf club 900 while the user trains with the golf club 900. For example, the user may receive feedback regarding the pressure the user applies to the handle of the golf club 900. Further, the user may receive feedback regarding a velocity or acceleration level of the golf club 900. The devices shown in FIGS. 4-9 are for illustrative purposes only as the pressure control system 100 may be used on various hand held devices as would be appreciated by one or ordinary skill in the art having the benefit of this disclosure.

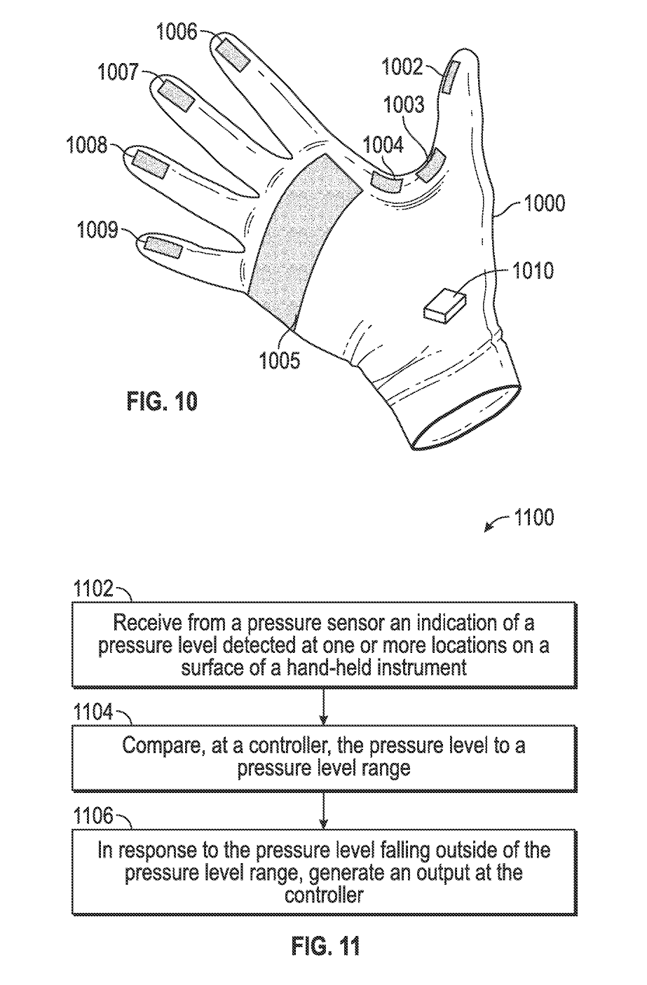

Referring to FIG. 10, an illustration of an embodiment of a glove 1000 usable with an interactive pressure control system is depicted. The glove 1000 may include multiple pressure sensors 1002-1009. The multiple pressure sensors 1002-1009 may be located at various locations on an inside surface or on an outside surface of the glove 1000. For example, the pressure sensor 1002 may be located at a thumb of the glove 1000. The pressure sensors 1003, 1004 may be located between the thumb and the index finger of the glove 1000. The pressure sensor 1005 may be located on the palm of the glove 1000. The pressure sensors 1006-1009 may be located on each finger of the glove 1000. Although FIG. 10 depicts a particular number and particular locations associated with the pressure sensors 1002-1009, it will be understood by persons skilled in the art that the number of pressure sensors may be increased or decreased and may be located at different locations on the glove 1000. The glove 1000 may further include at least one motion sensor 1010. The motion sensor 1010 may correspond to the motion sensor 116.

Rather than being tied to any particular tool or equipment, the glove 1000 may be used to measure pressure at locations on the surface of the glove while a user trains with various types of tools or equipment. For example, a user may hold the glove 1000 positioned between the user's hand and a particular tool or piece of equipment. The user may adjust user settings including stored pressure levels and/or stored velocity or acceleration levels to correspond to the particular tool or piece of equipment. For example, the user may adjust the user settings to select a target pressure level and/or a target velocity or acceleration level corresponding to a particular tool or piece of equipment. The target pressure level and/or velocity or acceleration level may be selected from a plurality of target pressure levels and/or velocity or acceleration levels corresponding to a plurality of tools or pieces of equipment. By using the glove 1000 in conjunction with the interactive pressure control system 100, a user of the glove 1000 may receive feedback regarding the pressure applied to particular locations of the inside of the glove 1000 while the user trains with the particular tool or piece of equipment. For example, the user may receive feedback regarding the pressure the user applies to the inside surface of the glove 1000 while using the particular tool or piece of equipment. Further, the user may receive feedback regarding a velocity or acceleration level of the glove 1000.

Referring to FIG. 11, a flow diagram of an embodiment of a method of performing interactive pressure control is depicted and generally designated 1100. The method 1100 may include receiving from a pressure sensor an indication of a pressure level detected at one or more locations on a surface of a handheld instrument, at 1102. For example, the controller 120 may receive an indication of a pressure level detected at one or more locations on the surface of the handheld instrument 110 from one or more of the pressure sensors 112-114.

The method 1100 may further include comparing, at a controller, the pressure level to a pressure level range, at 1104. For example, the controller 120 may compare the pressure level to a pressure level range based on the one or more stored pressure levels 132. The one or more stored pressure levels 132 may include a stored pressure level range or a pressure level range may be determined (e.g., on the fly) by the controller based on the stored pressure level.

The method 1100 may also include, in response to the pressure level falling outside of the pressure level range, generating an output at the controller, at 1106. For example, the controller 120 may generate an output to control one or more of the output devices 152-154 via the one or more output interfaces 140.

In one or more embodiments, any of the methods and/or operations described herein may be initiated or performed by a processor in response to processor readable instructions. For example, a non-transitory computer readable medium may include instructions that, when executed by a processor, cause the processor to initiate or perform the method 1100, another method or operation described herein, or a combination thereof. The non-transitory computer readable medium may include a memory device such as a random access memory (RAM) device, a read only memory (ROM) device, a magnetic memory device, a solid state memory device, a magnetic memory device, a compact disc, a digital video disc, another type of memory device, or any combination thereof.

Although various embodiments have been shown and described, the present disclosure is not so limited and will be understood to include all such modifications and variations are would be apparent to one skilled in the art.

What is claimed is:

1. A method comprising:
receiving from a pressure sensor an indication of a pressure level detected at one or more locations on a surface of a handheld instrument;
comparing, at a controller, the detected pressure level to a pressure level range; and
in response to the pressure level falling outside of the pressure level range, generating an output at the controller.

2. The method of claim 1, further comprising:
receiving from a motion sensor an indication of a velocity or acceleration level detected at the handheld instrument;
comparing, at the controller, the detected velocity or acceleration level to a velocity or acceleration level range; and
in response to the velocity or acceleration level falling outside of the velocity or acceleration level range, generating the output at the controller.

3. The method of claim 1, wherein the handheld instrument is a glove and wherein the surface is an inside surface or an outside surface of the glove.

4. The method of claim 1, wherein the handheld instrument is a shotgun forend, a shotgun hand grip, a shotgun cheek comb, a shotgun buttpad, a rifle forend, a rifle hand grip, a rifle cheek comb, a rifle buttpad, or a pistol grip.

5. The method of claim 1, wherein the handheld instrument is a baseball bat, a tennis racket, or a golf club.

6. The method of claim 1, wherein the output includes a change in a voltage or current at an output terminal, the change in the voltage detectable by a voltage or current meter.

7. The method of claim 1, wherein the output includes data sent to a liquid crystal diode (LCD) information display, to a light emitting diode (LED) bar graph level display, to an LED digital display, or a combination thereof.

8. The method of claim 1, wherein the output includes signals sent to a shaft or shaftless vibrate motor.

9. The method of claim 1, wherein the output includes signals sent to a buzzer or a speaker.

10. The method of claim 1, further comprising generating data indicative of a plurality of samplings of the pressure level at the one or more locations over a period of time.

11. The method of claim 10, further comprising sending the data indicative of the plurality of samplings to a remote computing device.

12. The method of claim 11, wherein the data is sent to the remote computing device via bluetooth, wifi, or wireless USB.

13. The method of claim 1, further comprising:
generating data indicative of a plurality of samplings of a velocity or acceleration level at the handheld instrument over a period of time; and
sending the data indicative of the plurality of samplings to a remote computing device.

14. The method of claim 1, further comprising:
receiving user input;
storing the user input as a stored pressure level, a stored velocity or acceleration level, or both;
generating the pressure level range, a velocity or acceleration level range, or both, based on the stored input.

15. A system comprising:
at least one pressure sensor coupled to a surface of a handheld instrument;
a controller, wherein an input of the controller is coupled to the at least one pressure sensor;
a memory device coupled to the controller, wherein the memory device includes a stored pressure level.

16. The system of claim 15, further comprising at least one motion sensor coupled to the handheld instrument and electronically coupled to the controller, wherein the memory device includes a stored velocity or acceleration level.

17. The system of claim 15, wherein the at least one pressure sensor includes a pressure resistant sensor, a capacitive sensor, an inductive sensor, a mechanical pressure sensor, or a combination thereof.

18. The system of claim 15, wherein the motion sensor comprises an accelerometer, a gyroscope, a camera, a radar, a range finder, or a combination thereof.

19. The system of claim 15, wherein the controller includes a comparator, an amplifier, an analog-to-digital converter, a micro-controller, or a combination thereof.

20. The system of claim 15, wherein the memory device includes a variable resistor, a variable capacitor, a digital register element, a random access memory (RAM) element, or a combination thereof.

21. The system of claim 15, further comprising an output interface coupled to the controller, wherein the output interface includes an audio output, a video output, a digital output, a data output, or a combination thereof.

22. An apparatus comprising:
a glove;
at least one pressure sensor coupled to a surface of the glove,
wherein the at least one pressure sensor is configured to measure a pressure level at a surface of the glove and send the pressure level to a controller to compare the pressure level to a pressure level range.

23. The apparatus of claim 22, further comprising at least one motion sensor coupled to the glove, wherein the at least one motion sensor is configured to measure a velocity or acceleration at the glove and send the velocity or acceleration to the controller.

24. The apparatus of claim 22, wherein the pressure level range corresponds to a target pressure level corresponding to a tool or piece of equipment.

25. The apparatus of claim 22, wherein the target pressure level is selected from a plurality of target pressure levels corresponding to a plurality of tools or pieces of equipment.
